(19) United States
(12) Patent Application Publication
(10) Pub. No.: US 2017/0055758 A1
(43) Pub. Date: Mar. 2, 2017

(54) FLAVOR INFUSING WATER FILTER ASSEMBLY

(71) Applicant: Cool Gear International, LLC, Plymouth, MA (US)

(72) Inventors: Donna Roth, Duxbury, MA (US); Henry Roth, Duxbury, MA (US); John D. Mason, Bridgewater, MA (US)

(21) Appl. No.: 15/307,796

(22) PCT Filed: May 13, 2015
(86) PCT No.: PCT/US2015/030520

§ 371 Date: Oct. 28, 2016

Related U.S. Application Data
(60) Provisional application No. 61/992,823, filed on May 13, 2014.

(51) Int. Cl. A47J 31/06; C02F 1/00; C02F 1/28

(52) U.S. Cl. CPC A47J 31/0636; C02F 1/283; C02F 1/003; C02F 2307/04

(57) ABSTRACT

A filtration system for a container includes a basket that holds a filter assembly and a flavor infuser, where the basket is suspended over at least a portion of an opening of the container. The filtration system may further include the filter assembly. The filter assembly may further include a filter assembly bottom and a filter assembly top.

### CROSS REFERENCE TO RELATED APPLICATIONS

This application claims priority to and the benefit of co-pending U.S. Application Ser. No. 61/992,823, filed May 13, 2014, the full disclosure of which is hereby incorporated by reference in its entirety for all purposes.

### FIELD OF THE DISCLOSURE

This disclosure relates to containers including filters, and more particularly, to containers including filters and flavor infusing systems.

### BACKGROUND

The human body contains between 55-78% water, depending on body mass. The human body requires about 1-5 liters of water per day to avoid dehydration and function properly. Many people drink water from sources that require, or are perceived as requiring, filtration (e.g., lakes, streams, wells, public water supplies, and the like). Additionally, some people enjoy flavoring their water or other liquids through infusion of fresh fruit, flavoring packets, and the like. Solutions for providing filtered and infused water are needed.

### SUMMARY

In at least one aspect of this disclosure, a filtration system for a container includes a basket configured to hold a filter assembly and a flavor infuser, where the basket is configured to suspend over at least a portion of an opening of the container.

The filtration system may further include the filter assembly. The filter assembly may further include a filter assembly bottom and a filter assembly top.

In some embodiments, at least one of the filter assembly bottom and the filter assembly top is formed from the basket. The filter assembly bottom and the filter assembly top may be welded together. In some embodiments, the filter assembly includes a carbon filter disposed therein.

The filtration system may further include the flavor infuser. The flavor infuser may include an elongated chamber including a plurality of apertures, the elongated chamber configured to hang into an internal cavity of the container below the basket. In some embodiments, the flavor infuser is removable from the basket. In other embodiments, the flavor infuser may be formed from the basket.

In at least one aspect of this disclosure, a container includes a basket configured to hold a filter assembly and a flavor infuser, wherein the basket is suspended over at least a portion of an opening of the container. The container may further include the filter assembly. The container may further include the flavor infuser.

In some embodiments, the basket and the container may be formed together. The container may be a pitcher or any other suitable container. Other aspects and embodiments of this disclosure are discussed infra.

### BRIEF DESCRIPTION OF THE DRAWINGS

The above and other objects, features and advantages of this disclosure will be more clearly understood from the following detailed description when taken in conjunction with the accompanying drawings, in which:

FIG. 1 is a perspective view of an exemplary embodiment of a container in accordance with this disclosure, showing a filtration assembly disposed therein;

FIG. 2 is a cross-sectional side view of the container of FIG. 1, showing the filtration assembly in cross-section;

FIG. 3 is an exploded side view of the container of FIG. 1;

FIG. 4 is a top plan view of the container of FIG. 1; and

FIG. 5 is a perspective exploded view of a filter assembly in accordance with this disclosure.

### DETAILED DESCRIPTION OF THE EMBODIMENTS

Hereinafter reference will now be made in detail to various embodiments of the subject disclosure, examples of which are illustrated in the accompanying drawings and described below. While example embodiments are described, it will be understood that the present disclosure is not limited to those exemplary embodiments. On the contrary, this disclosure covers not only the embodiments described herein, but also various alternatives, modifications, equivalents and other embodiments, which may be included within the spirit and scope of the disclosure.

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

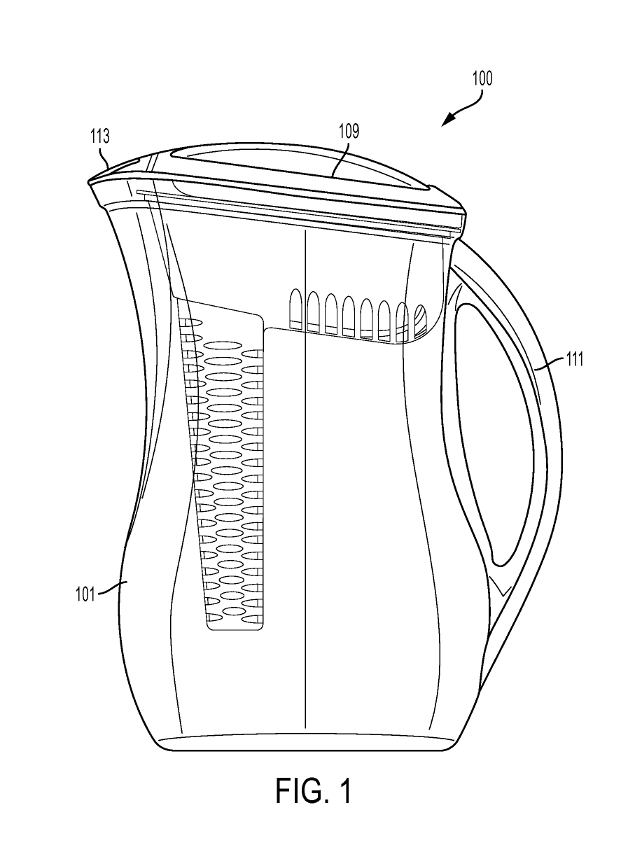

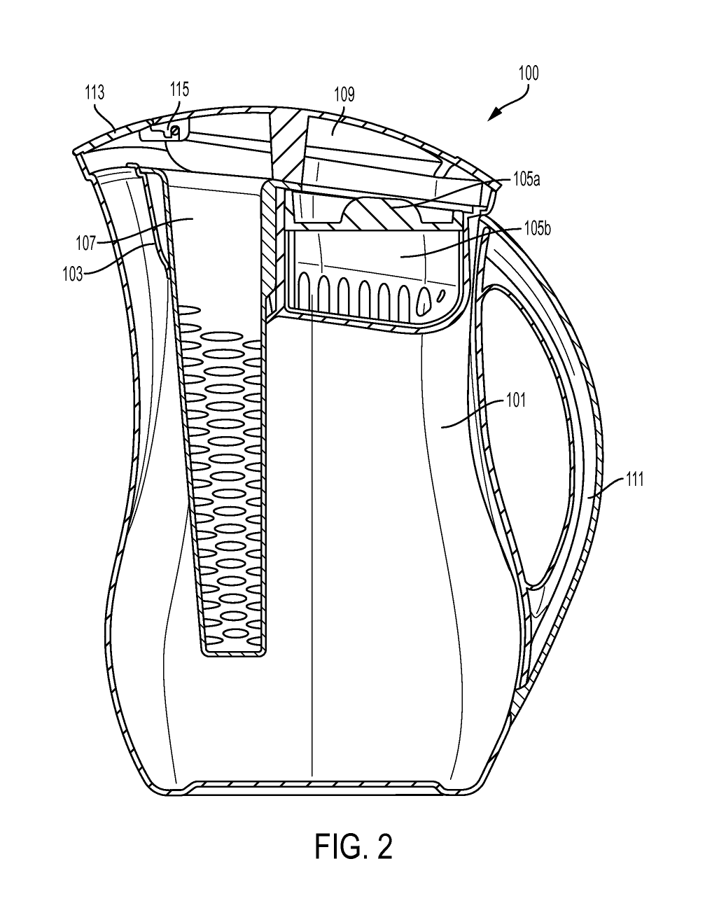

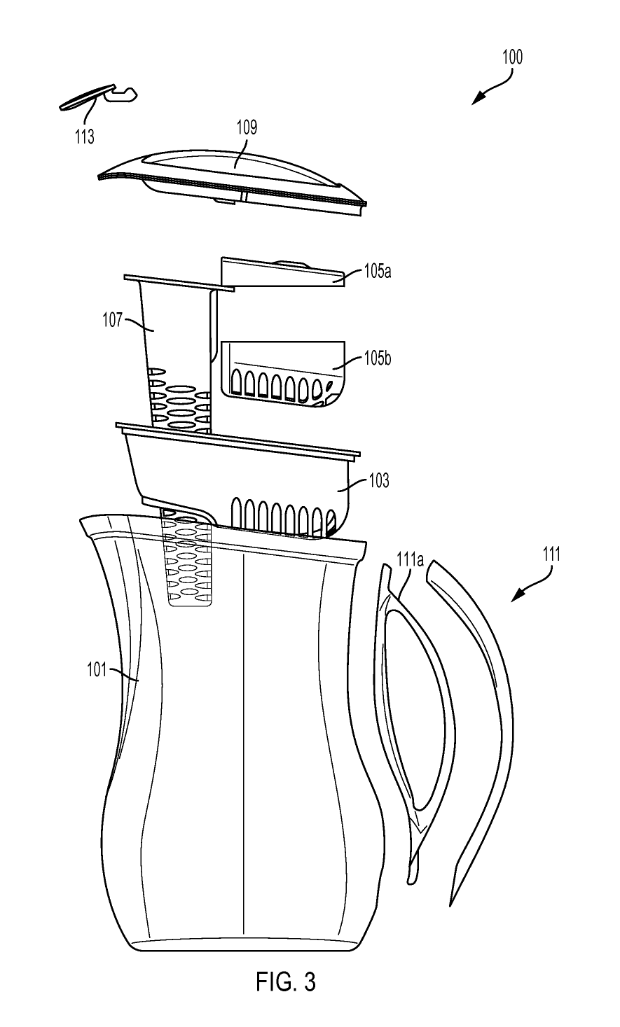

Unless specifically stated or obvious from context, as used herein, the term “about” and similar terms (e.g., “substantially”, “approximately”) are understood as within a range of normal tolerance in the art, for example within 2 standard deviations of the mean. Such terms can be understood as meaning within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”Referring to FIG. 1, filtration system 100 may include a container 101 having a lid 109 and handle 111. Lid 109 may further include a flap 113 that covers an opening from which liquid may be dispensed from container 101. As shown in FIG. 2, flap 113 may be connected to lid 109 via hinged connection 115. As shown in FIG. 3, handle 111 may also include an internal component 111a.

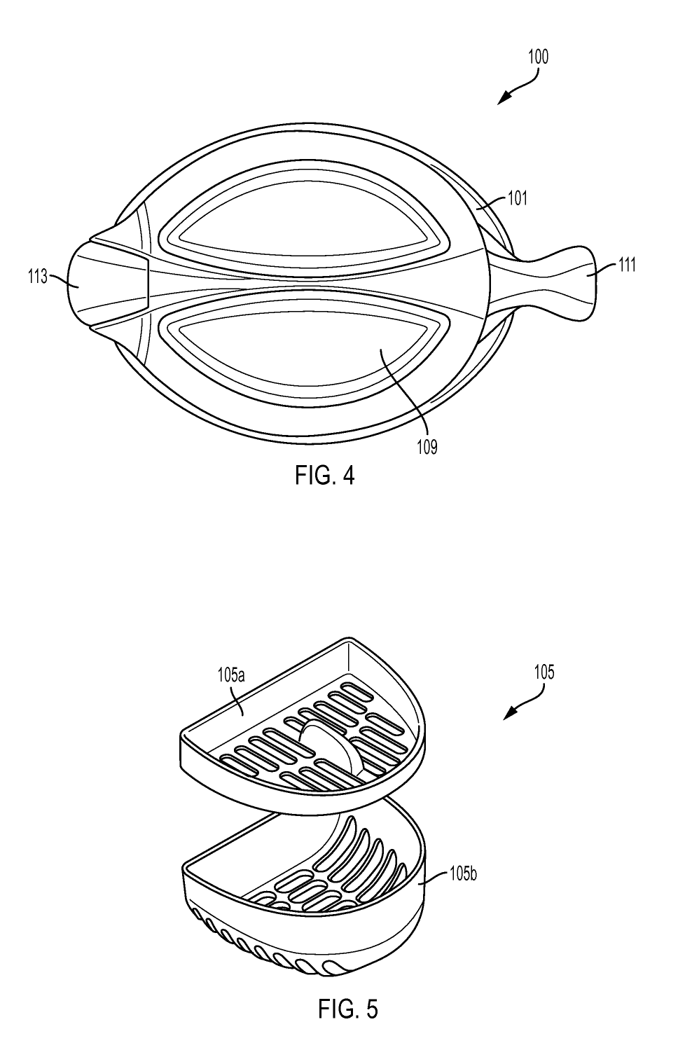

Referring to FIGS. 1-5, in at least one aspect of this disclosure, a filtration system for a container 101 includes a basket 103 configured to suspend over at least a portion of an opening of the container 101 and also configured to hold a filter assembly 105 (e.g., see FIG. 5) and a flavor infuser 107. As shown in FIG. 2, the filter assembly 105 may further include a filter assembly bottom 105b and a filter assembly top 105a. In some embodiments, at least one of the filter assembly bottom 105b and the filter assembly top 105a may be formed from the basket 103 such that the basket 103 and at least a portion of the filter assembly 105 (e.g. the filter assembly bottom 105b) form part of the basket 103.

In some embodiments, the filter assembly bottom 105b and the filter assembly top 105a may be welded or otherwise connected together with a filter element disposed therebetween such that each portion is not removable from each other. In other embodiments, the filter assembly top 105a and the filter assembly bottom 105b may be separable such that the filter element therein may be removed and/or replaced. The filter assembly 105 may be configured to contain a liquid filter disposed therein (not shown). One of skill in the art will appreciate that the liquid filter may be any one of a variety known in the art such as, for example, a carbon filter, an activated carbon filter, a carbon block filter, a granulated activated carbon filter, a ceramic filter, a deionization filter, a fibredyne block filter, an ion exchange resin filter/column, a mechanical filter (e.g., a screen), and the like. The filter assembly 105 may be further configured to include a gasket or seal positioned between the filter assembly top 105a and the filter assembly bottom 105b.

The filtration system 100 may further include the flavor infuser 107 configured to receive any of a variety of flavor sources including, but not limited to, fruit (e.g., whole fruit, cut fruit, crushed fruit, and the like), packets or cartridges of flavoring (e.g., tea, artificial flavorings, etc.), and the like. As shown, the flavor infuser 107 may include an elongated chamber including a plurality of apertures, the elongated chamber configured to hang into an internal cavity of the container 101 below the basket 103. The flavor infuser 107 may be of any other suitable shape or size.

In some embodiments, the flavor infuser 107 is removable from the basket 103. In other embodiments, the flavor infuser 107 may be formed from the basket 103 such that the basket 103 and the flavor infuser 107 form a continuous piece of material.

In at least one aspect of this disclosure, a container 100 includes a basket 103 configured to hold a filter assembly 105 and a flavor infuser 107, where the basket 103 is suspended over at least a portion of an opening of the container 101. The container 101 may further include the filter assembly 105. The container 101 may further include the flavor infuser 107.

In some embodiments, the basket 103 and the container 101 may be formed together or otherwise permanently connected to each other. As shown, the container 101 may be a pitcher. It will be understood by one having ordinary skill in the art that the container 101 may be any other suitable container, such as a bottle, mug, thermos, sports container, and/or the like, and may be made of any suitable material (e.g., plastic, metal, glass, and the like). The container 101 may also include a lid 109.

Any of the herein described components of the various embodiments of the filtration system may made with any suitable materials, including, but not limited to, plastic, metal, and/or ceramics.

While the disclosed embodiments have been described in detail, it will be appreciated by those skilled in the art that changes may be made in these embodiments without departing from the principles and spirit of the disclosure.

What is claimed is:

1. A filtration system for a container, comprising:
a basket configured to hold a filter assembly and a flavor infuser, wherein the basket is configured to suspend over at least a portion of an opening of the container.

2. The filtration system of claim 1, further including the filter assembly.

3. The filtration system of claim 2, wherein the filter assembly includes a filter assembly bottom and a filter assembly top.

4. The filtration system of claim 3, wherein at least one of the filter assembly bottom and the filter assembly top is formed from the basket.

5. The filtration system of claim 3, wherein the filter assembly bottom and the filter assembly top are welded together.

6. The filtration system of claim 2, wherein the filter assembly includes a carbon filter.

7. The filtration system of claim 1, further including the flavor infuser.

8. The filtration system of claim 7, wherein the flavor infuser includes an elongated chamber including a plurality of apertures, the elongated chamber configured to hang into an internal cavity of the container below the basket.

9. The filtration system of claim 7, wherein the flavor infuser is removable from the basket.

10. The filtration system of claim 7, wherein the flavor infuser is formed from the basket.

11. The filtration system of claim 1, wherein the container is a pitcher.

12. A container, comprising:
a basket configured to hold a filter assembly and a flavor infuser, wherein the basket is suspended over at least a portion of an opening of the container.

13. The container of claim 12, further including the filter assembly.

14. The container of claim 13, wherein the filter assembly includes a carbon filter.

15. The container of claim 12, further including the flavor infuser.

16. The container of claim 15, wherein the flavor infuser includes an elongated chamber including a plurality of apertures, the elongated chamber configured to hang into an internal cavity of the container below the basket.

17. The container of claim 15, wherein the flavor infuser is formed from the basket.

18. The container of claim 12, wherein the basket and the container are formed together.

19. The container of claim 12, wherein the container is a pitcher.
